(19) United States
(12) Patent Application Publication
(10) Pub. No.: US 2015/0140556 A1
(43) Pub. Date: May 21, 2015

(54) OPTICAL FIBER WITH GRATING AND PARTICULATE COATING

(71) Applicant: SPARTAN BIOSCIENCE INC., Ottawa (CA)

(72) Inventors: Jacques Albert, Gatineau (CA); Anatoli Ianoul, Nepean (CA); Aliaksandr Bialiayeu, Ottawa (CA); Adam Bottomley, Sundridge (CA)

(21) Appl. No.: 14/409,429

(22) PCT Filed: Jun. 20, 2013
(86) PCT No.: PCT/IB2013/003025

§ 371 Date: Dec. 18, 2014

Related U.S. Application Data
(60) Provisional application No. 61/662,212, filed on Jun. 20, 2012.

(51) Int. Cl. G02B 6/02; G01N 21/65; G01N 21/64

(52) U.S. Cl. CPC G02B 6/02057; G01N 21/64; G01N 21/645; G01N 21/65; G01N 21/658; G01N 2201/08; G01N 2021/6484
USPC 435/6.11; 385/37; 250/458.1; 250/459.1; 356/301; 422/69; 422/82.11; 435/6.12; 435/7.36; 435/287.2; 422/82.08; 436/501; 250/216

(57) ABSTRACT

The present invention provides, in addition to other things, methods, systems, and apparatuses that involve the use of an optical fiber with grating and particulate coating that enables simultaneous heating; optical detection; and optionally temperature measurement. Methods, systems, and apparatuses of the present invention may be used in many applications including isothermal and/or thermal cycling reactions. In certain embodiments, the present invention provides methods, systems, and apparatuses for use in detecting, quantifying and/or identifying one or more known or unknown analytes in a sample.

### RELATED APPLICATIONS

This application claims the benefit of U.S. Provisional Application No. 61/662,212, filed on Jun. 20, 2012, the disclosure of which is incorporated herein by reference.

### BACKGROUND

Optical fibers may be used to transport significant power in the form of guided electromagnetic radiation over long distances with little loss. For example, fibers for long-distance communications have a propagation loss lower than 0.3 dB/km. Typically, power exits the end of the fiber. It is possible to multiplex several light beams inside an optical fiber, and therefore use a single fiber for both heating and exciting fluorescence at its output end. In these cases, the exit surface of light is limited by the cross-section of the fiber (which typically has a diameter between 8 μm and 100 μm).

U.S. Patent Application Number 2009/0263072 (the entire contents of which are incorporated herein by reference) describes a sensor, comprising: a sensing surface exposed to the medium; an optical pathway; and a grating in the optical pathway. The grating, also known as a Bragg grating or fiber Bragg grating (FBG) or tilted fiber Bragg grating (TFBG), allows light to exit the fiber at locations other than the output end. The sensing surface may be a homogenous or heterogeneous metallic coating that is continuous. The grating may induce surface plasmon resonance in proximity to the sensing surface. The actual sensing takes place using refractometry of the target analytes of interest. While this disclosure describes sensing, it does not address, let alone describe or enable heating, and also does not address let alone describe or enable extracting light from the fiber to excite photo-luminescence in materials outside the fiber.

Caldas et al (2011) describe an optical fiber coated with a silver film and containing two types of gratings: a “long period grating” (LPG) and a separate fiber Bragg grating (FBG) (Caldas P et al. (2011). Fiber optic hot-wire flowmeter based on a metallic coated hybrid long period grating/fiber Bragg grating structure. Applied Optics. 50(17): 2738-2743). Light passing through the LPG is absorbed by the silver film and heats it up. This configuration allows heating to take place in a location other than the fiber's output end. Light passing through the FBG is used to measure the temperature under the coating. The apparatus described in this reference may be able to achieve heating and temperature sensing, however it does not and cannot achieve fluorescent detection because light cannot pass through the silver film. In addition, the apparatus requires two separate types of grating, which is more costly to manufacture than a single type of grating.

Chen et al (2004) describe an optical fiber coated with a silver coating and containing a fiber Bragg Grating (FBG) (Chen K P, Cashdollar U, Xu W (2004) Controlling fiber Bragg grating spectra with in-fiber diode laser light. IEEE Photonics Technology Letters. 16(8): 1897-1899). Unlike Caldas et al, the device described in Chen et al includes only an FBG and no LPG. The trade-off is that high power light is required to heat the silver coating. This approach requires a light source which consumes more energy and is more expensive. Similar to Caldas et al, Chen et al's apparatus does not and cannot achieve optical detection of target analytes because light cannot pass through the silver coating.

Gao et al (2011) describe an optical fiber which contains a short section in which an absorbing fiber has been spliced in (Gao S et al. (2011) All-optical fiber anemometer based on laser heated fiber Bragg gratings. Optics Express. 19(11): 10124-10130). The absorbing fiber absorbs light and generates heat locally. An FBG in the absorbing section is used to measure the local temperature. An additional FBG located nearby, but not in the absorbing section, is used to provide a temperature reference for the non-heated portion of the fiber. Theoretically, this apparatus could be used for both heating and fluorescent detection by using one wavelength of light to heat the absorbing fiber, and a different wavelength of light to excite fluorescent molecules in the surrounding media, but to do so would require a coupling mechanism to extract guided light from the core; Gao et al do not even propose, let alone describe or enable any such system. The apparatus of Gao et al has the further disadvantage that a separate absorbing fiber must be spliced in to the optical fiber. This requirement makes manufacturing more difficult.

### SUMMARY

The present invention encompasses the recognition that, for certain diagnostic applications, it would be advantageous to be able to heat and excite fluorescence along a length of an optical fiber rather than just at its output end. For example, real-time Polymerase Chain Reaction (PCR) uses cycles of heating and cooling to amplify DNA. Amplified DNA may be detected using fluorescent probes. In another example, isothermal DNA amplification requires constant heating at a temperature such as 65° C. and the increase in DNA may be detected using fluorescent probes or dyes. In another example, the Fluorescent Treponemal Antibody Absorption test requires the sample to be heated prior to fluorescent detection of Treponema pallidum, the bacterium that causes syphilis. In yet another example, photo-thermal cancer therapy selectively heats certain tissues using light absorption. The temperature reached must be kept within strict tolerances in order to be effective in killing cancerous cells while keeping non-cancerous cells unharmed. In all of these applications, heat and light must be delivered simultaneously or in succession to the tissue or sample to be treated or examined, and the local temperature must be known in real time.

In certain aspects, the present invention provides methods, systems, and apparatuses for analyzing analytes. In one aspect, the present invention provides methods and apparatuses that involve the use of an optical fiber with grating and a particulate coating that enables simultaneous heating and optical detection. In some embodiments provided methods, systems and apparatuses also enable temperature measurement. In some embodiments, provided methods and/or apparatus may be used for detection, quantification, and/or identification of one or more target analytes in a biological sample. In some embodiments, provided methods and/or apparatus may be used for detection, quantification, and/or identification of one or more target analytes in a chemical sample. In some embodiments, provided methods and/or apparatus may be used for detection, quantification, and/or identification of one or more target analytes in an unknown sample. In some such embodiments, provided methods and/or apparatus are utilized for detection, quantification, and/or identification of a plurality of target analytes (e.g., a plurality of molecules) within a sample.

In some embodiments, provided methods and/or apparatuses are used for analyzing one or more physical, chemical or biological properties of a particular analyte (e.g., molecule) over a range of temperatures. In some embodiments, provided methods and/or apparatuses are used for analyzing a plurality of such analytes at a single or various temperatures, so that similarities and/or differences in physical, chemical or biological properties between or among such analytes are identified and/or characterized.

For example, in some embodiments, provided methods and/or apparatuses are used to determine and/or assess one or more properties selected from the group consisting of solubility, melting temp, flash point, volatility, fluorescence, luminescence, cis-trans isomerisation, etc. In some embodiments, provided methods and/or apparatuses are used to analyze a plurality of different analytes in a sample, in some embodiments to determine and/or assess interactions (e.g., associations and/or dissociations) between or among them.

In some embodiments, a sample is heated. In some such embodiments, such heating facilitates or promotes precipitation of one or more analytes (e.g., molecules) within or from the sample; in some such embodiments, heating and/or precipitation enhances detection, analysis, and/or identification of one or more analytes in or from the sample. In some embodiments, heating facilitates or promotes association and/or dissociation of analytes within or from the sample; in some such embodiments, such association or dissociation involves formation or disruption of an interaction selected from the group consisting of single, double or triple bond formation, ionic interactions, polymerization, and combinations thereof.

In some embodiments, a heated sample is analyzed to assess sample purity. To give but a few examples, in some embodiments, a pharmaceutical mixture or composition may be heated and analyzed to determine (e.g., detect and/or quantify) presence and/or level of a chemical contaminant. In some embodiments, a pharmaceutical mixture or composition may be heated and analyzed for quality control purposes (e.g., as part of a quality control procedure), for example to determine (e.g., detect and/or quantify) presence and/or level of an unwanted contaminant (e.g., degradant, by-product, etc.).

In some embodiments, a heated sample is analyzed to assess generation and/or disruption of higher-order structures, for example selected from the group consisting of homo- and/or hetero-dimers, trimers, tetramers, pentamers, and combinations thereof, of analytes in or from the sample. In some embodiments, such higher-order structures include DNA and/or RNA structures selected from the group consisting of duplexes, hairpins, and other secondary, tertiary or quaternary structures, and combinations thereof.

In some embodiments of the present invention, analysis includes determining or analyzing optical activity. In some embodiments, optical activity is determined for a sample containing or intended to contain a racemic analyte; in some such embodiments presence or level of another component affects optical activity of a sample containing the racemic analyte, such that the sample (or fraction thereof) is not racemic when the other component is present (e.g., above a threshold minimum level).

In some embodiments, a provided apparatus comprises an optical fiber with grating and particulate coating located over at least a portion of the grating. It is to be understood that the terms “particulate coating” and “particles” are used herein to refer to spheroid particles (e.g., cubes, near cubic rectangles, spheres, near spherical ellipsoids, and other irregular shapes with substantially similar dimensions in all directions) but also particles with asymmetric shapes with substantially different dimensions in at least two directions such as metal nanowires and carbon nanotubes. In certain embodiments, such coating is at least partially transparent to light in the visible range of the spectrum. Alternatively or additionally, in some embodiments, such coating is substantially opaque to longer wavelength radiation, e.g., infrared radiation including near infrared radiation. More generally, in some embodiments the particulate coating is at least partially transparent to radiation of a first wavelength and substantially opaque to radiation of a second wavelength. In some embodiments, the apparatus is arranged and constructed (e.g., through use of an appropriate such coating, for example partially transparent to visible light and substantially opaque to near infrared radiation) so that infrared light (e.g., near infrared light) may be used to heat up the coating to a particular temperature (e.g., a desired and/or predetermined temperature).

In some embodiments, metal particles such as, but not limited to, silver, gold, copper, aluminum, nickel, titanium, cadmium, iron, tin, lead, zinc, etc., may be used. One skilled in the art, reviewing the present disclosure, will appreciate that, while the use of metal particles may help provide for the efficient transfer of light into heat at infrared wavelengths, a variety of materials may alternatively or additionally be used. Thus, other materials that are partially transparent to light in the visible range and opaque to longer wavelengths, may be used in accordance with the current invention to produce the desired effect. In some embodiments, a coating material is characterized by particular thermal conductivity (e.g., within a range of 1-1000 W/mK). In some embodiments, a coating material is characterized by a high heat capacity. In some embodiments, a coating material is characterized by a low heat capacity.

In certain embodiments, practice of the present invention involves exposing a sample to visible light in or on a provided apparatus containing an optical fiber with a particulate coating as described herein, and otherwise arranged and constructed as described herein so that presence, level, and/or one or more characteristics of an analyte in the vicinity of the optical fiber, or attached to its particulate coating, is detected, analyzed, or determined The present invention encompasses the recognition that use of particulate coatings comprising metal particles, permits transmission of visible light and enables plasmonic effects to enhance the electromagnetic field intensity in between the particles. Those of ordinary skill in the art, reading the present disclosure, will appreciate that enhancement of electromagnetic field intensity may be accomplished with suitable materials other than metal particles; use of such suitable materials is within the scope of the present invention.

In some embodiments, the size, spacing and permittivity of the metal particles in the particulate coating allow the excitation of surface plasmon resonances (SPR) at the wavelengths of interest. SPR greatly amplifies the fluorescence of fluorescent molecules in a liquid around the fiber because of the large enhancement of electromagnetic field intensity. This SPR effect may be advantageous for applications involving fluorescent molecules, such as real-time PCR with fluorescent probes.

In some embodiments, visible light is shone down the optical fiber, passes through the particulate coating, and excites fluorescent agents in a liquid around the fiber. In some embodiments, the fluorescence is detected using a camera. In other embodiments, the fluorescence is detected using a photodiode. In both cases, SPR effects can be used to enhance the fluorescence. This improves detection sensitivity and increases the signal-to-noise ratio.

In some embodiments, the temperature of the particulate coating is measured by launching a light signal into the same fiber, where the signal covers at least a few nanometers of bandwidth, but at wavelengths different than those used for heating or fluorescence excitation. The grating provides a detectable reflection signal, which may be analyzed to provide real-time temperature measurement.

### BRIEF DESCRIPTION OF THE FIGURES

FIG. 1 represents a diagram of an exemplary tilted fiber Bragg grating (TFBG) with: (i) a Tunable Laser (TL) with fiber amplifier (EDFA) and polarization control (PC); ii) a fluorescence (FL) excitation source; and iii) a broadband source (BBS) with optical spectrum analyzer (OSA). All of these instruments are fiber-coupled and multiplexed on the same single-mode fiber using low-cost, low-loss fiber couplers. In the example instrument depicted in FIG. 1, the TL is a near-infrared tunable laser that heats up the particulate coating; the EDFA is a fiber amplifier that increases the laser power used for heating; the PC is a polarization controller that optimizes the coupling of the heating laser light towards the particulate coating; the BBS is a broadband light source that interrogates the grating for temperature measurement; and the OSA is an optical spectrum analyzer that measures the core mode reflection peak wavelength for temperature measurement.

FIG. 2 illustrates a side-view schematic of an exemplary fiber with a tilted fiber grating (not to scale). In the exemplary schematic, the yellow rectangles represent a discontinuous particulate coating that functions as a semi-transparent cladding. The guided incident light is coupled into: i) reflected light; ii) near infrared (NIR) light guided by the cladding; and iii) visible (VIS) light out-coupled from the fiber and through the cladding.

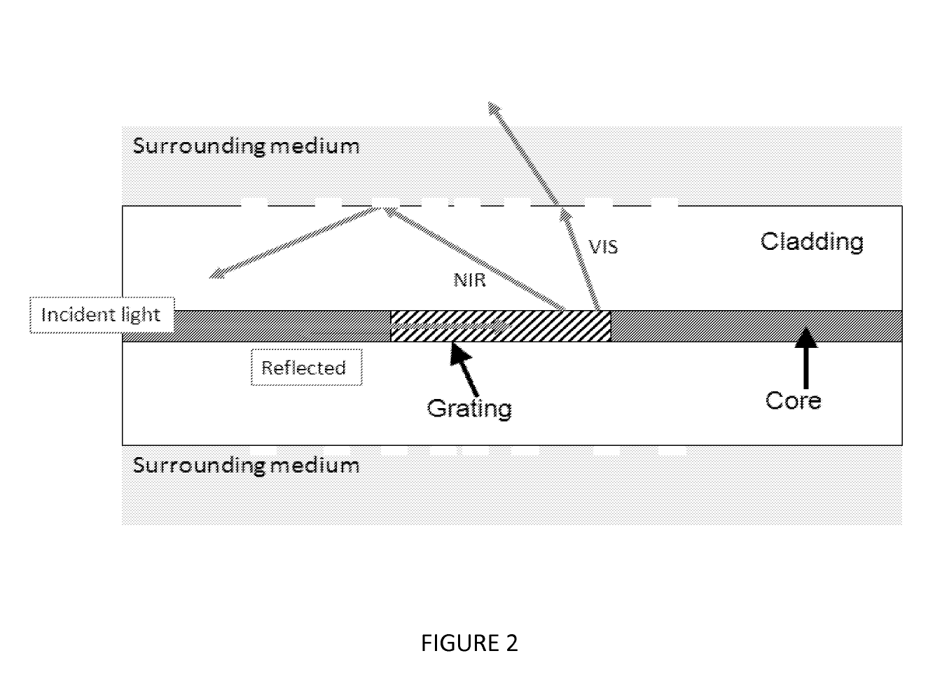

FIG. 3 demonstrates transmission spectrum of a TFBG fiber with silver-nanowire particulate coating.

FIG. 4 demonstrates temperature measurements of a TFBG fiber with particulate coating.

FIG. 5 illustrates the evolution of core mode back reflection resonance in the transmission spectrum.

FIG. 6 illustrates measurement of the temperature increase temporal response.

FIG. 7 illustrates measurement of the temperature decrease temporal response.

FIG. 8 demonstrates an exemplary TFBG fiber immersed in a solution containing Rhodamine 6G.

FIG. 9 demonstrates light extracted our of a fiber by a TFBG but without particulate coating and in air. The light is observed striking a white screen located underneath the fiber.

FIG. 10 demonstrates light scattered out of a TFBG fiber and through the particulate coating.

### DETAILED DESCRIPTION

In certain aspects, methods of the present invention involve the use of an optical fiber with grating and a particulate coating that enables simultaneous heating; fluorescent detection; and optionally temperature measurement. The grating is imprinted in the fiber core, and may be of any length between 1 and 100 mm (e.g., between 1-10, 1-20, 1-30, 1-40, 1-50, 1-60, 1-70, 1-80, 1-90, 10-20, 10-30, 10-40, 10-50, 10-60, 10-70, 10-80, 10-90, 10-100, 25-50, 25-75, 25-100, 50-75 or 50-100 mm) This defines a limited “region of interaction” between the light and the area surrounding the fiber, including coatings.

In general, a variety of optical fiber types may be used for practicing the present invention. In some embodiments, the optical fiber may be a silica fiber (e.g., a doped silica fiber). In some embodiments, the optical fiber may be a plastic optical fiber. In some embodiments, the optical fiber may be a chalcogenide glass fiber. It will be appreciated that these are not the only types of optical fibers that could be used.

In certain embodiments, an optical fiber with grating and particulate coating is immersed in a sample, optionally contained within a chamber, to facilitate heating and fluorescence detection of an analyte within the sample. In some embodiments, the optical fiber and sample (with optional chamber) are part of a system of the present invention which may include additional components, e.g., a source of radiation (e.g., a laser or lamp), means for coupling radiation from the source into the optical fiber (e.g., a fiber optic coupler), means for managing the transport of the sample and optical fiber into the chamber (e.g., a manual or robotic handling system), means for cooling the sample (e.g., liquid coolant or forced ventilation), means for detecting analyte(s) in the sample once excited by radiation emanating from the optical fiber (e.g., a detector in communication with a computer system which processes signals received from the detector), etc. In some embodiments, the optical fiber is at least partially immersed in a sample. In some embodiments, at least 1, 2, 3, 4, 5, 6, 7, 8, 9, 10, 15, 20, 25, 30, 35, 40, 45, 50, 55, 60, 65, 70, 75, 80, 85, 90, 95, or 100 mm of the optical fiber is immersed in a sample. In some embodiments the entire region of interaction of the optical fiber is immersed in a sample.

In some embodiments, the sample comprises an unknown analyte. In some embodiments, the sample contains a plurality of unknown analytes. In some embodiments, the sample contains an analyte from a biological sample. In some embodiments, the biological sample is derived from a mammal In some embodiments, the mammal is a human. In some embodiments the sample is obtained or derived (e.g., by processing a primary sample that is obtained) from a human patient, who may or may not manifest physical symptoms of a disease, disorder or condition such as a genetic disease, disorder, or condition. In some embodiments, the sample is suspected of containing an infectious agent capable of infecting a mammal, such as, but not limited to a bacterium, virus, prion, fungus, protozoan or amoeba. In some embodiments, the sample is suspected of containing a known or unknown chemical, toxin and/or drug.

In some embodiments, practice of the present invention involves analyzing one or more test samples. In some embodiments, practice of the present invention involves analyzing one or more reference samples (i.e., samples containing a known level and/or type of relevant analyte whose presence, level, identity, or other feature or characteristic is of interest). In some embodiments, practice of the present invention involves analyzing one or more test samples and comparing results with those of comparable analysis of one or more reference samples, whether historical, simultaneous, or subsequently assessed.

In some embodiments, analyzed samples are liquid samples. In some embodiments, a sample comprises an aqueous liquid. In some embodiments, an aqueous liquid comprises one or more analytes (e.g., in solution or suspension) such as, but not limited to, divalent cations, salt, buffer, glycerol, detergent, phosholipid, alcohol, amino acid and/or combinations thereof, for performing a biological reaction. In some embodiments, the sample comprises an organic liquid. In some embodiments, the sample comprises a mixture of at least one aqueous liquid and at least one organic liquid.

In some embodiments, an apparatus utilized in accordance with the present invention comprises a sample chamber that is cylindrical in shape. In some embodiments, the chamber is conical in shape. In some embodiments, the chamber is cylindrical in shape with a tapered bottom end. In some embodiments, the chamber is composed of a material comprising an inert polymer, such as, but not limited to, polyvinylchloride, polyethylene or polypropylene. In some embodiments, the chamber is composed of a material comprising a heat retentive material. In some embodiments, the chamber is composed of a material comprising poor thermal conductivity. In some embodiments, the chamber is composed of a material that is transparent to visible light. In some embodiments, the chamber is composed of a material that is both transparent to visible light and does not luminesce under visible light. In some embodiments, the chamber is less than 10, 9, 8, 7, 6, 5, 4, 3, or 2 times the circumference of the optical fiber, to minimize the volume of sample fluid needed to cover the optical fiber.

In some embodiments, analytes are labeled, for example with fluorescent dyes. In some such embodiments, utilized dyes are excited by light coupled out of the fiber by the TFBG through the particulate coating. In some embodiments, such analytes being detected and/or analyzed (e.g., labeled analytes) are or comprise nucleic acids. In some embodiments, the nucleic acid comprises one or more DNA strands, optionally hybridized to at least one other nucleic acid. In some embodiments, the nucleic acid comprises one or more RNA strands, optionally hybridized to at least one other nucleic acid. In some embodiments, RNA is or comprises mRNA, shRNA, miRNA, tRNA, siRNA,and/or rRNA.

In some embodiments, analytes being detected and/or analyzed (e.g., labeled analytes) are or comprise a chemical, toxin and/or drug. In some embodiments, analytes are or comprise an amino acid. In some embodiments, analytes are or comprise polypeptides.

In some embodiments, the present invention utilizes a fluorescent dye that is or comprises a dye specific to double stranded DNA, such as, but not limited to, SYBR Green, Ethidium Bromide, Acridine organge or propidium iodide. In some embodiments, the fluorescent dye comprises a flurophore selected from the group consisting of: 6-carboxyfluoroscein (FAM), tetracholorogluoroscein (TET), HEX, TAMRA, ROX, CY3, CY3.5, Texax Red, Rhodamine Red, CY5, Cy5.5, Cy7, Alexa dye, Cal Fluor dye and/or combinations thereof. In some embodiments, the fluorescence moiety comprises a quantum dot.

In some embodiments, the present invention utilizes a dye which is attached to the 5′ end of a nucleic acid. In some embodiments, a dye is attached to the 3′ end of a nucleic acid. In some embodiments, the nucleic acid comprises both a dye and quencher arranged and/or configured for fluorescence resonance energy transfer (FRET). In some embodiments, luminescence intensity of oligonucleotides labeled with fluorescent dyes is enhanced by SPR effects in and around the particulate coating.

In some embodiments, temperature measurement is accomplished using light from a light-emitting diode multiplexed into the fiber using a wavelength selective coupler; in some embodiments, detection utilizes an optical spectrum analyzer (OSA) to determine peak reflected wavelength. Alternatively or additionally, a tunable laser source and photodetector may be utilized. It will be appreciated by one skilled in the art, that any light source coupled in single mode fiber may be used, provided the wavelengths used are within the single mode regime of the fiber and preferably not overlapping with the wavelengths used for heating and for luminescence.

Manufacture of Optical Fibers with Gratings and Particulate Coatings

The grating to be used inside the fiber must be of a type that allows coupling of the core guided light to the cladding of the fiber. While tilted gratings are used to demonstrate certain embodiments herein, it will recognized by those familiar with the art that other kinds of fiber gratings can perform the same function (e.g., any kind of grating that does not cover the fiber cross-section uniformly).

Tilted fiber gratings are produced using available methodologies, including for example well-established techniques used for conventional fiber gratings. For example, in some embodiments, a fiber is exposed to two diverging or converging intense ultraviolet light beams that produce a short-period interference pattern perpendicular to the fiber core axis. A photochemical reaction then fixes the modulated pattern in the fiber core, which then becomes a permanent hologram. This hologram interacts with incident guided light to: i) reflect it back; ii) couple it out of the core as a new optical mode guided by the cladding; and iii) radiating light that escapes the fiber. For a given tilted grating period and tilt angle, these three consequences occur at different wavelengths.

Once a grating is produced, a heat treatment step stabilizes the grating pattern for long term use. For a particulate coating, the fiber surface may be prepared by immersing it in various solutions, and finally in a suspension of particles (e.g., metal particles) that precipitate on the fiber surface. In some embodiments, the particulate coating is or comprises a sparse layer of silver particles (e.g., spheroid silver nanoparticles or silver nanowires). One skilled in the art, reviewing the present disclosure, will appreciate that, while the use of metal particles may help provide for the efficient transfer of light into heat at infrared wavelengths, a variety of materials may alternatively or additionally be used. In some embodiments, metal particles such as, but not limited to, silver, gold, copper, aluminum, nickel, titanium, cadmium, iron, tin, lead, zinc, etc. may be used. Alternatively or additionally, other materials that are partially transparent to light in the visible range and opaque to longer wavelengths, may be used in accordance with the current invention to produce the desired effect. In some embodiments, a coating material is characterized by a particular thermal conductivity (e.g., within a range of 1-1000 W/mK). In some embodiments, a coating material is characterized by a high heat capacity. In some embodiments, a coating material is characterized by a low heat capacity. Those skilled in the art will also recognize that nanoparticle coatings (i.e., such as those described above) may be deposited on the fiber surface by means other than immersing it in solution, such as Chemical Vapor Deposition, Thermal Evaporation, Sputtering, and Atomic Layer Deposition, all standard techniques used to produce uniform or particulate coatings on materials.

In some embodiments, a particulate coating comprises spheroid particles (e.g., cubes, near cubic rectangles, spheres, near spherical ellipsoids, and other irregular shapes with near identical dimensions in all directions). In some embodiments the spheroid particles have dimensions between 1 and 5000 nm, e.g., between 1 and 1000 nm, between 10 and 500 nm, between 10 and 300 nm, between 15 and 200 nm, or between 30 and 100 nm.

In some embodiments, a particulate coating comprises particles with asymmetric shapes such as metal nanowires and carbon nanotubes. In some embodiments these particles have a diameter between 1 and 1000 nm, e.g., between 1 and 500 nm, between 10 and 500 nm, between 10 and 300 nm, between 10 and 200 nm, or between 10 and 100 nm and a length between 500 and 20000 nm, e.g., between 500 and 10000 nm, between 500 and 5000 nm, or between 1000 and 5000 nm.

In some embodiments, a particulate coating covers at least 5, 10, 15, 20, 25, 30, 35, 40, 45, 50, 55, 60, 65, 70, 75, 80, 85, 90, 95 or 100% of the surface of the “region of interaction” (previously defined as the region of the fiber where light passing down the fiber interacts with the area surrounding the fiber, including coatings). In general, the level of coverage can be obtained by imaging a representative sample of the fiber surface (using either atomic force microscopy or scanning electron microscopy) and counting the fraction of pixels that include a particle as compared to the fraction of pixels where the fiber is bare. It will be appreciated that this can be achieved using a variety of software tools that have been developed to perform this type of image analysis. In some embodiments, a particulate coating covers between 10 and 90%, e.g., 20-80, 30-70 or 40-60% of the surface of the region of interaction. In some embodiments the region of interaction is co-extensive with the region defined by the grating. In some embodiments the region of interaction has a length between 1 and 100 mm (e.g., between 1-10, 1-20, 1-30, 1-40, 1-50, 1-60, 1-70, 1-80, 1-90, 10-20, 10-30, 10-40, 10-50, 10-60, 10-70, 10-80, 10-90, 10-100, 25-50, 25-75, 25-100, 50-75 or 50-100 mm) In some embodiments the particulate coating may extend beyond the region of interaction. In some embodiments, a particulate coating covers at least 5, 10, 15, 20, 25, 30, 35, 40, 45, 50, 55, 60, 65, 70, 75, 80, 85, 90, 95 or 100% of the surface of the optical fiber located over the grating. In some embodiments, a particulate coating covers between 10 and 90%, e.g., 20-80, 30-70 or 40-60% of the surface of the optical fiber located over the grating. In some embodiments the particulate coating may extend beyond the grating.

In some embodiments, the present utilized fiber comprises a coating (with a coverage within one of the aforementioned ranges, e.g., 10-90% coverage) over a length ranging from 1-100 mm (e.g., 1-10, 1-50, 1-80, 5-25, 5-75, 15-50, 25-75 mm). In some embodiments, the coating exists in a plurality of discontinuous sections each ranging from 1-100 mm in size (e.g., 1-10, 1-50, 1-80, 5-25, 5-75, 15-50, 25-75 mm) where each section comprises a coating with a coverage within one of the aforementioned ranges (e.g., 10-90% coverage). In some embodiments the discontinuous sections are all co-extensive with the region of interaction. In some embodiments, the plurality of discontinuous sections comprise the same coating. In some embodiments, the plurality of discontinuous sections comprises at least two sections with different coatings. In some embodiments, the different coatings have a different chemical or physical property. It is further contemplated that functionalization of the fiber/metal particle surfaces may be performed to allow for the attachment of labeled oligonucleotides, proteins, chemical or drugs to the outer surface of the fiber.

In some embodiments, the present utilized fiber comprises a coating with a thickness in the range of 1 to 5000 nm, e.g., between 1 and 1000 nm, between 10 and 500 nm or between 30 and 100 nm. In general it will be appreciated that the nature of the particles used in the coating along with thickness and coverage of the particulate coating will affect the properties of the apparatuses of the present invention (e.g., a thicker coating may require less coverage to achieve the same effect as a thinner coating of the same particles). It will also be appreciated that these parameters can be tuned depending on the application of the apparatus in question including the type of radiation, type of sample, type of analytes, etc.

In some embodiments, the particulate coating is uniform across a length of optical fiber. Such a configuration allows for uniform heating in a linear configuration of liquids or materials in contact with the coating. In some embodiments, the particulate coating is not uniform across a length of optical fiber. For example, one part of the coating may be adjusted so that it absorbs more light and thus achieves a higher heating temperature than another part of the coating that is adjusted to absorb less light. For example, for liquid phase deposition of the coating, this may be accomplished using gradual immersion into the liquid. In another example, for chemical vapor deposition of the coating, this may be accomplished using temperature gradients along the fiber during the deposition of the gases. In some embodiments, the temperature profile of the non-uniform heating is controllable by adjusting the coating at different points along the fiber. These embodiments enable non-uniform heating of liquids or materials in contact with the coating.

In yet further embodiments, the particulate coating is uniform but the coupling strength of the grating is non-uniform across the length of the fiber. This changes the amount of pump light reaching the coating at different points along its length. The coupling strength as a function of position is readily controlled during the grating fabrication using methods well known in the art. For example, the laser used to create the grating may be varied in intensity at different lengths along the fiber. The temperature profile of the non-uniform heating is directly controllable by adjusting coupling strength at different points along the fiber. This embodiment also enables non-uniform heating of liquids or materials in contact with the coating.

In some embodiments, visible light is shone down the optical fiber, passes through the particulate coating, and excites fluorescent agents in a liquid around the fiber. In some embodiments, the light shone down the optical fiber comprises one or more wavelengths in the range of 200 to 5000 nm, e.g., between 350 and 2000 nm or between 400 and 1500 nm. Due to the linear configuration of the particulate coating along the length of the fiber, the excitation light is also emitted in a linear configuration. It will be appreciated by one skilled in the art, that such a linear configuration is advantageous because line sources of light are easily collimated or refocused using cylindrical optics, such as, but not limited to, the use of parabolic mirrors.

In some embodiments, the present invention utilizes fiber/metal particles derivatized with a binding agent. In some embodiments, the fiber/metal particles are derivatized with a plurality of different binding agents. In some embodiments, the binding agent is used to link a target analyte (i.e., protein, nucleic acid, chemical, drug, antibody or combinations thereof) to the optical fiber. In some embodiments, the binding agent is a biological and/or chemical linking agent selected from the group consisting of biotin, streptavidin, chitin binding domain, maltose binding domain, Glutathione-S-Transferase, 6-histidine, Hemagutinin, NHS ester, and “click-chemistry”.

In some embodiments, different functional materials may be attached to the particulate coating along its length. For example, different oligonucleotides may be attached to different areas of the particulate coating. This would enable hybridization of different complementary nucleic acids at different points along the fiber, enabling applications such as positional multiplexing. It will be appreciated by one skilled in the art that any manner of different functional materials may be attached to the particulate coating using a variety of methods, such as, but not limited to, those described herein.

### Polymerase Chain Reaction

Polymerase Chain Reaction (PCR) is a well-known method for amplifying DNA using alternating cycles of heating and cooling. An optical fiber with grating and particulate coating may be used to perform this thermal cycling, e.g., by using near infrared light to heat up the particulate coating. Temperature cycling may be accomplished by adjusting the power of the infrared light in a cyclical fashion. For example, a pump laser may be turned on for several seconds until the grating temperature signal reaches the desired level for the desired duration, and then turned off Auxiliary cooling may be provided (either with liquid coolant or forced ventilation) to accelerate the cooling part of the PCR cycle. In some embodiments, an active cooling device may be used, such as, but not limited to, a Peltier based device, a fan, thermal heat sink and/or combinations thereof. The process may be repeated any number of times.

It will be appreciated by one skilled in the art, that any thermal cycling nucleic acid amplification-based technique may be used in accordance with the methods of the invention. For example, a nucleic acid in an unknown biological sample may be amplified using traditional PCR methods. In other certain embodiments, reverse transcriptase polymerase chain reaction (RT-PCR) may be used. RT-PCR is a well-known technique in the art which relies upon the enzyme reverse transcriptase to reverse transcribe mRNA to form cDNA, which can then be amplified in a standard PCR reaction. Both PCR and RT-PCR can be carried out in a qualitative or quantitative manner. Methods for quantitative detection using Real-time quantitative PCR are well-known in the art and have been thoroughly described in the literature (see Gibson et al, Genome Res., 6(10):995-1001 (1996)), using a variety of techniques such as hydrolytic probes (TaqMan™), hairpin probes (Molecular Beacons), FRET probe pairs (LightCycler™), hairpin probes attached to primers (Scorpion™), hairpin primers (Plexor™ and Amplifluor™), DzyNA and oligonucleotide blocker systems.

Real-time quantitative techniques for use with the invention, produce a fluorescent read-out that can be continuously monitored over time. Visible (VIS) light out-coupled from the fiber and through the particulate coating may be used to excite fluorescent molecules. In the case of Real-time PCR, fluorescence signals are generated by dyes that are specific to double stranded DNA, like SYBR Green, which become incorporated during amplification, or by sequence-specific fluorescently labeled oligonucleotide primers or probes. This fluorescence may be detected using the methods and apparatus of the invention, coupled with imaging systems or photodetectors. Selective wavelength filters may be used to improve the specificity of the fluorescent detection. In some embodiments, a plurality of selective wavelength filters may be used to detect different fluorescing molecules from different locations, adjacent, discontiguous or contiguous with one another, on a coated fiber. In some embodiments, an imaging system may be used to image different parts of a fiber onto different regions of a recording camera system, such as a CCD array to enable simultaneous detection of one or more analytes within a sample.

In some embodiments, light shining through the particulate coating is used to excite a Raman scattering signal from analytes attached to the coating or dispersed in a liquid adjacent to the coating. In such embodiments, SPR enhancement of the Raman scattering signal (so-called “Surface Enhance Raman Spectroscopy”) is expected in and around the metallic coating. Surface plasmon resonance (SPR) enhancement of the out-coupled visible light requires that the wavelength of the light be within the resonance bandwidth of the SPR. This resonance bandwidth is a function of the size and surface coverage of the metal particles in the particulate coating. For a random array of irregular metal nanoparticles, this resonance occurs over several tens of nanometers and is easily designed.

The enhancement of electromagnetic field-induced phenomena in the vicinity of metal nanoparticles via plasmon effects is well known (Mayer K M. et al. (2011), Chemical Reviews; 111(6): 3828-3857; Ianoul A et al., (2006), Langmuir, 22(24): 10217-22; the content of both of which are hereby incorporated by reference). The fluorescent molecules may be in a liquid around the fiber, or may be affixed to the particulate coating.

### Isothermal Amplification

In another aspect of the invention, a nucleic acid may be amplified using any of a variety of single temperature (isothermal) amplification methods. Examples include, without limitation, isothermal amplification techniques such as NASBA, 3SR, TMA, rolling circle, ligase chain reaction (LCR), Loop-mediated isothermal amplification (LAMP), Invader technology, strand displacement amplification (SDA), helicase dependent amplification (HDA), recombinase polymerase amplification (RPA) and Q-beta-replicase.

### Multiplexing

In one aspect of the invention, it is contemplated that a multiplex assay may be used, to detect several target sequences within the same sample chamber. For example, a series of target specific primers or probes may be labeled with different fluorescent dyes and used in conjunction with the methods and apparatus of the invention to assay an unknown and/or known sample. Such an approach is referred to as “differential” multiplexing, since the different spectral emission from the various dyes, determines the presence and/or absence of a specific target sequence. In other embodiments, the current invention may be used to perform “positional” multiplexing, in which the geographic location of the fluorescence signal, may be used to determine the identity of a specific target. For example, fluorescently labeled FRET hairpin oligonucleotides may be attached to different discrete positions along the coated fiber of the current invention (i.e., in discrete banding patters along the fiber). Following heating and amplification of the sample, an unknown target nucleic acid hybridizes to its complementary recognition site on the fiber. Generation of a fluorescence signal and its coordinate location on the fiber, are indicative of the presence and identity of the target nucleic acid. In yet further embodiments, multiplexing may be performed using a fluorescence dye in combination with a non-fluorescent readout. For example, each target specific primer or probe may be coupled with a non-fluorescent indicator such as a bead (of varying shape, size or color) or bar code. The combination of both the fluorescent signal and the visual reference, are used to determine the presence and identity of the unknown target sequence.

### Sequencing

In certain embodiments, various sequencing approaches may be performed in accordance with the methods and apparatus of the invention. In one specific example, methylation-specific PCR (MSP) may be used. MSP may be used to detect methylation of CpG islands in genomic DNA. Briefly, DNA is first treated with sodium bisulfate, which converts unmethylated cytosine bases to uracil, which is recognized by PCR primers as thymine Two PCRs are then carried out on the modified DNA, using primer sets identical except at any CpG islands within the primer sequences. At these points, one primer set recognizes DNA with cytosines to amplify methylated DNA, and one set recognizes DNA with uracil or thymine to amplify unmethylated DNA. (See, Herman et al. (1996), P.N.A.S., vol. 93, pgs. 9821-26, which is incorporated herein by reference in its entirety). This technique can detect methylation changes as small as 0.1%. In addition to methylation of CpG islands, many of the sequences surrounding clinically relevant hypermethylated CpG islands can also be hypermethylated, and are potential biomarkers. In some embodiments, the MSP is real-time quantitative MSP (QMSP) which permits reliable quantification of methylated DNA. The QMSP method is based on the continuous optical monitoring of a fluorogenic PCR. This PCR approach can detect aberrant methylation patterns in human samples with substantial (1:10.000) contamination of normal DNA. (See Eads et al., (2000) Nucl Acids Res 28(8):E32; which is incorporated herein by reference). Moreover, QMSP is amenable to high-throughput techniques allowing the analysis of close to 400 samples in less than 2 hours without requirement for gel electrophoresis.

### Temperature Detection

Temperature at the grating is representative of the temperature of the fluid immediately adjacent to the fiber because of the grating's small size and thermal mass relative to the fluid. Temperature at the grating may be determined by illuminating it with a light source of known wavelength, and then measuring the exact peak wavelength of the reflected light using a fiber coupler or circulator. It is well known that the peak wavelength of the reflected light from an optical fiber grating shifts at a rate of about 11 pm/degree Celsius. In some embodiments, shift rate for the reflected light is empirically determined for each individual optical fiber. Thus, one may measure the wavelength of the peak at a known temperature to obtain a reference point. Temperature changes may then be determined by monitoring the change in peak wavelength relative to the reference point. Such temperature changes may be monitored continuously or at specific points in time.

### EXAMPLES

The invention will be more fully understood by reference to the following examples. They should not, however, be construed as limiting the scope of the invention. All literature citations are incorporated by reference.

### Example 1

### Grating Fabrication

For the examples described herein, the TFBG was produced using a standard telecommunications single-mode fiber (CORNING SMF 28). One-meter-long fiber strands were placed in a pressurized container that was filled with pure Hydrogen gas at a typical pressure of 2500 psi for a period of at least 14 days. The fiber strands were then taken out of the container and prepared for UV irradiation: a 5-cm-long section of the fiber polymer jacket was removed with a stripping tool to expose the glass cladding. The fiber was connected to a broadband light source (covering the 1510 nm to 1620 nm wavelength range) and to an optical spectrum analyzer. The exposed part of the fiber was positioned on the downstream side of a diffractive grating and exposed to intense pulses of ultraviolet light at 193 nm generated by an excimer laser (any wavelength between 190 nm and 248 nm may be used). The power density of the pulses were 40 mJ/cm² at the fiber, and the pulse repetition rate was 100 Hz. It will be understood and appreciated by one skilled in the art, that alternative parameters (power density of the pulses and pulse repletion) may be used. After a few minutes of irradiation, the diffraction pattern generated by the diffractive grating was reproduced in the fiber core, and remained permanent. Tilting the phase mask allowed for the fabrication of fiber gratings with grating planes. This was done using a large rotation stage to hold the fiber and phase mask holders, as well as a cylindrical lens (100 mm focal length) that focuses the incoming UV light onto the fiber.

### Example 2

### Coating Fabrication

This example describes one kind of particulate coating that will serve as an exemplary embodiment. Silver nanowires were chemically synthesized as described in Sanders et al. (Sanders A W et al. (2006) Nano Lett, 6(8): 1822-1826; the entirety of which is hereby incorporated by reference). The procedure results in highly crystalline nanowires with smooth surfaces.

In brief, all reagents were obtained from Sigma-Aldrich. All glassware was cleaned using aqua regia, rinsed in 18.2 MΩXcm deionized water, and placed in an oven to dry prior to experimentation. A 50-mL round bottom flask containing 24.0 mL of anhydrous 99.8% ethylene glycol (EG) and a clean stir bar were placed in an oil bath set to 150° C. and allowed to sit for 1 hour. Using a micropipette, 400 μL of 3 mM sodium sulfide dissolved in EG was added to the flask. Ten minutes later, 6 mL of EG containing 0.12 g of dissolved polyvinylpyrolidone (PVP) with a molecular weight of 55000 AMU was injected using a glass syringe. This was immediately followed by the injection of 0.5 mL of 6 mM HCl. After an additional 5 minutes, 2.0 mL of 282 mM 99%+ silver nitrate dissolved in EG was injected slowly using a glass syringe. Upon addition of the silver nitrate, the solution immediately turned black and slowly became a transparent yellow, then changed to an ochre color while some plating in the flask occurred. The reaction was allowed to continue until the solution became white. The reaction was monitored by periodically taking small aliquots out of the reaction flask using a Pasteur pipette and dispersing it in a cuvette filled with 95% ethanol for UV-visible spectroscopy. The reaction was quenched by placing the flask in an ice bath after the solution had fully become white and turbid in appearance.

The nanowires were purified by adding 20 mL of ethanol to the solution and centrifuging it at 13800 g for 20 minutes to remove the excess PVP, EG, and any reaction by-products. The supernatant was then discarded and the rods were re-dispersed in ethanol by sonication. This process was repeated several times at 400 g to separate out the heavier wires from the solution.

Finally, the nanowires were deposited on the optical fiber using the following process. The bare fiber with the TFBG was submerged in piranha solution (H₂SO₄/H₂O₂) for 20 minutes followed by a 1% (v/v) solution of 3-aminopropyltrimethoxysilane in methanol for an additional 20 minutes. Then the fiber was left in the nanowire solution for 24 hours. The fiber was removed, rinsed in methanol, and dried under a stream of nitrogen. The resulting nanowires had an average diameter of 100 nm, average length of 5 μm, and the coverage of the fiber surface (fraction of the surface covered by metal) was 14%.

### Example 3

### Heating of the Particulate Coating on the TFBG Fiber

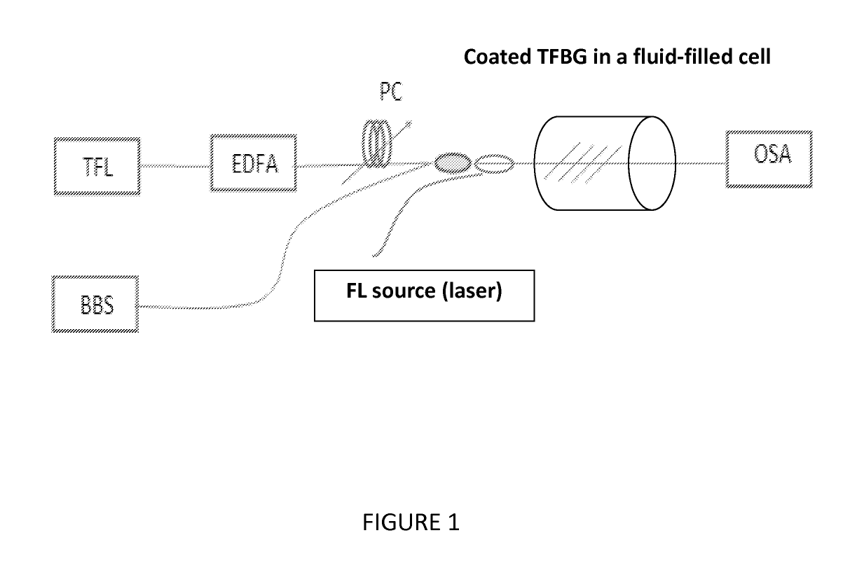

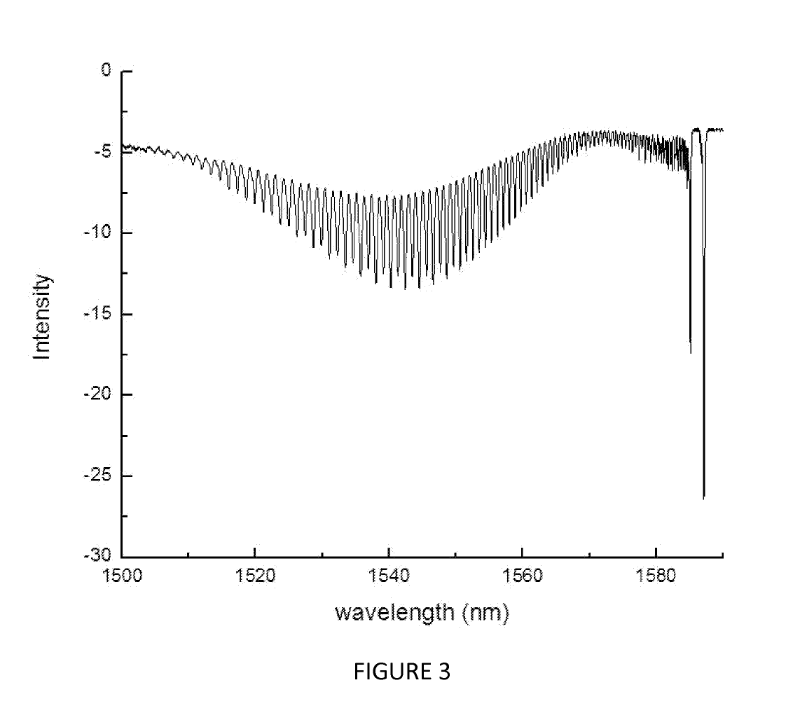

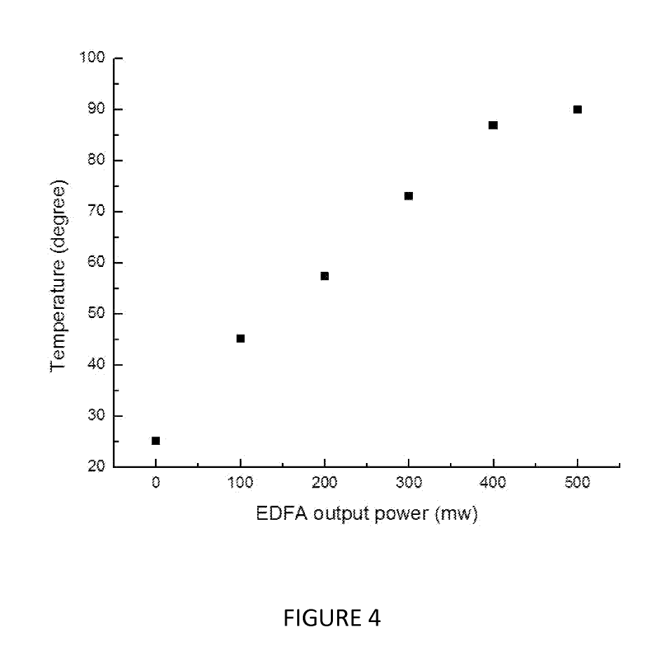

A TFBG fiber with particulate coating was manufactured according to Examples 1 and 2. A near-infrared tunable laser (TL) was tuned to the maximum absorption of the TFBG. FIG. 3 shows that maximum absorption occurs at a wavelength of approximately 1540 nm. The fiber amplifier (EDFA) was set to increase the power to any desired level between 1 mW and 1 W. For the example, the TFBG fiber with particulate coating was placed in a glass capillary tube with an inner diameter of 1 mm. The capillary was filled with water. A conventional electrical thermocouple was inserted in the capillary to measure the temperature of the liquid adjacent to the grating. The near-infrared tunable laser was set to 1540 nm and the EDFA varied the output power from 0 mW to 500 mW. As demonstrated in FIG. 4, temperatures of the order of 90° C. may be achieved with less than 1 W of optical power in the fiber. (FIG. 1, shows an illustrative example diagraming the various elements and their configuration/arrangement used in the application described in Example 3).

### Example 4

### Temperature Measurement of the TFBG Fiber with Particulate Coating

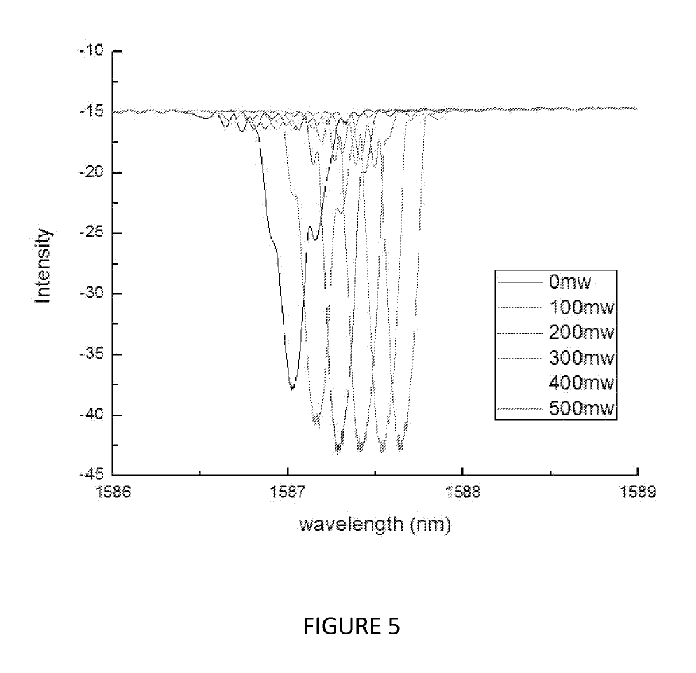

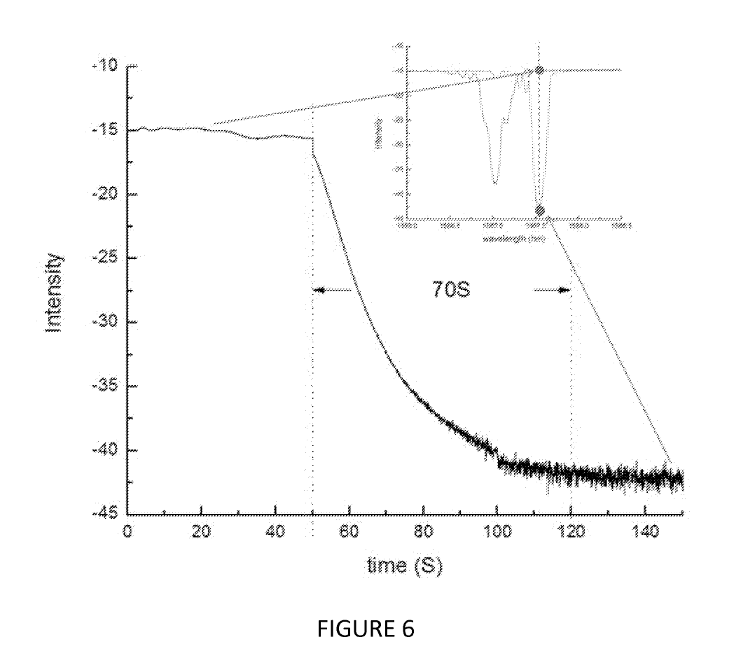

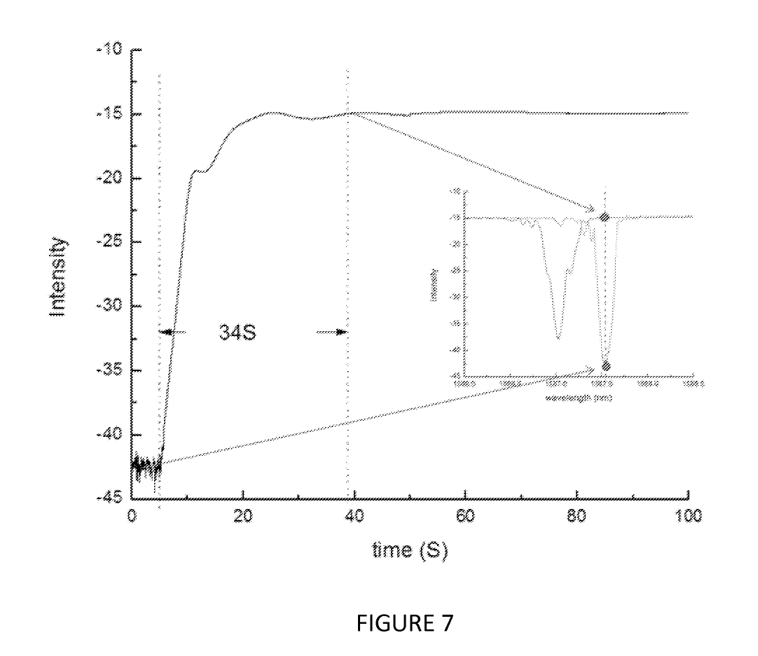

Example 4 demonstrates real-time temperature measurements of the TFBG fiber with particulate coating. The fibers used in this experiment had a temperature dependence of the reflection wavelength of the order of 11 pm/° C. The reflection wavelength was monitored by coupling in the fiber light with a spectral range of a few nanometers and detecting it with an optical spectrum analyzer (ANDO AQ6317B) that provides a measure of optical power versus wavelength. The light source for this measurement was an amplified spontaneous emission source (JDSU BBS1560) that emits broadband light from 1520 nm to 1620 nm, with a spectral power density of −30 dBm/0.01 nm in a single-mode optical fiber. The grating that was used for these experiments had a core mode reflection resonance of 1587 nm. This value of 1587 nm was revealed by a notch (or peak for reflection) in the spectrum. The temperature at this reflection resonance of 1587 nm provided a calibration value for determining a wavelength-temperature curve. FIG. 5 shows how the back-reflection from the core mode appears in the transmission spectrum and how it shifts with pumping, thereby revealing the temperature increase. Table 1 presents temperature measurements of the heated fiber obtained from the TFBG wavelength, as compared to adjacent measurements with a simple thermocouple. The two columns of results (λ_{Peak} and λ_{Central}) refer to two possible methods of extracting the temperature information from the grating transmission spectrum. FIGS. 6 and 7 show results from an indirect measurement of the response time, obtained by measuring the power at a fixed wavelength while the TFBG response shifted due to heating or cooling. For these experiments, the optical spectrum analyzer was set to “scan zero” mode, where the power is measured at a single wavelength as a function of time.

TABLE 1
Temperature measurements of the heated fiber

| EDFA Power | Heating in water with pump | |
|---|---|---|
| (T measurement using | λ_{Peak} | λ_{Central} |

| thermometer) | (° C.) | σ(° C.) | (° C.) | σ(° C.) |
|---|---|---|---|---|
| 0 mW (25.1° C.) | 25.1 | 0.3 | 25.1 | 0.05 |
| 100 mW (39.6° C.) | 38.6 | 0.9 | 37.5 | 0.2 |
| 200 mW (52.2° C.) | 51.8 | 0.9 | 50.1 | 0.1 |
| 300 mW (63.9° C.) | 64.6 | 1.1 | 60.5 | 0.08 |
| 400 mW (75.1° C.) | 76.3 | 0.8 | 68.1 | 0.1 |
| 500 mW (84.1° C.) | 86.8 | 0.8 | 78.3 | 0.1 |

### Example 5

### Light Transmission through Particulate Coating on TFBG

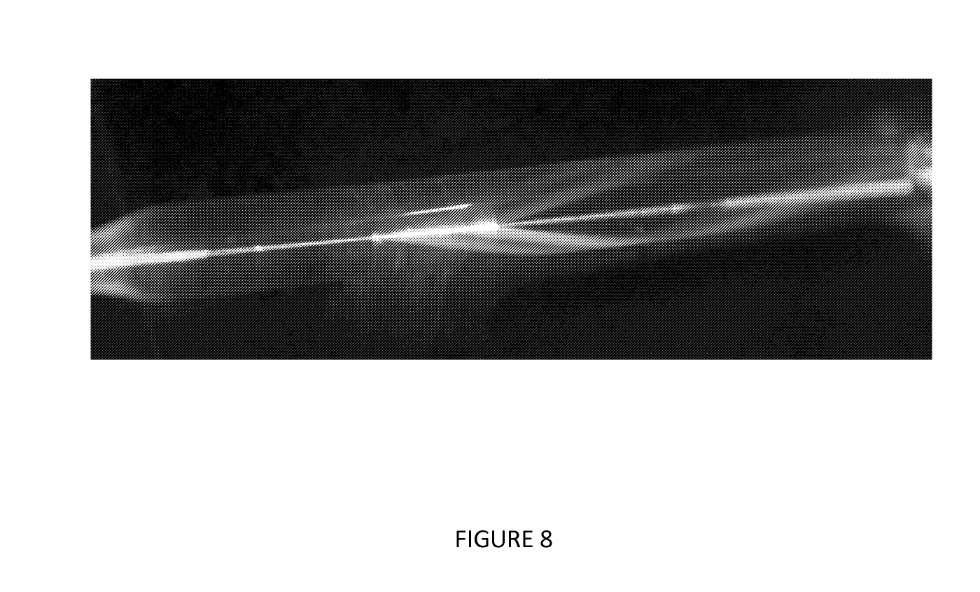

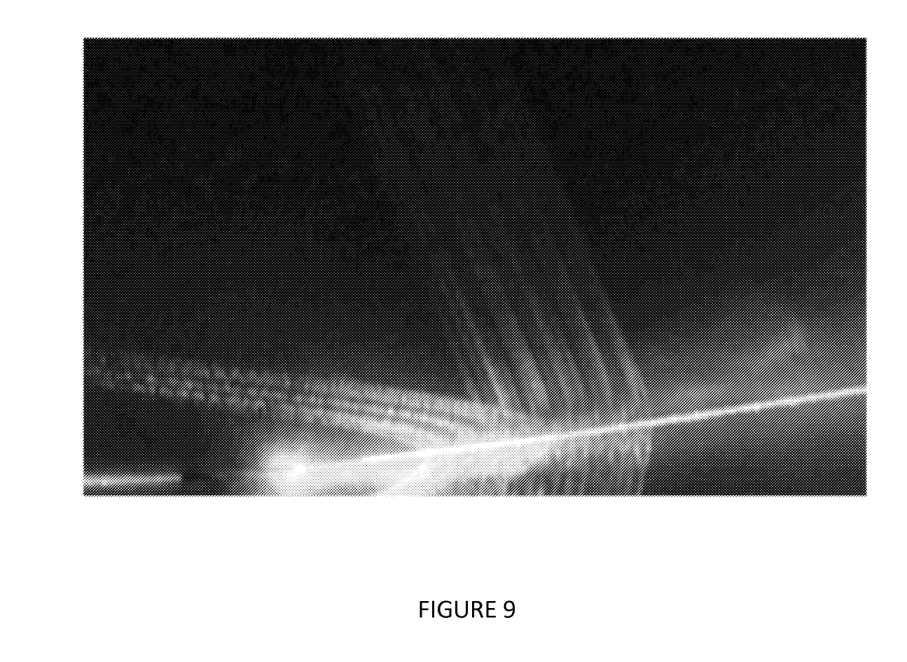

For Example 5, a series of experiments were carried out to demonstrate the difference in light transmission between a bare TFBG and a TFBG with particulate coating. For the bare TFBG, the end of the fiber containing the TFBG was immersed in a narrow test tube containing a solution of Rhodamine 6G 10⁻⁶M. Light from an Argon ion laser (514 nm) was launched into the input end of the optical fiber using a 20× microscope objective and micro-position stages to line up the input fiber end to the laser beam. FIGS. 8 and 9 were obtained by imaging the fiber from the side of the test tube, with a standard color CCD camera and imaging lenses of various magnification.

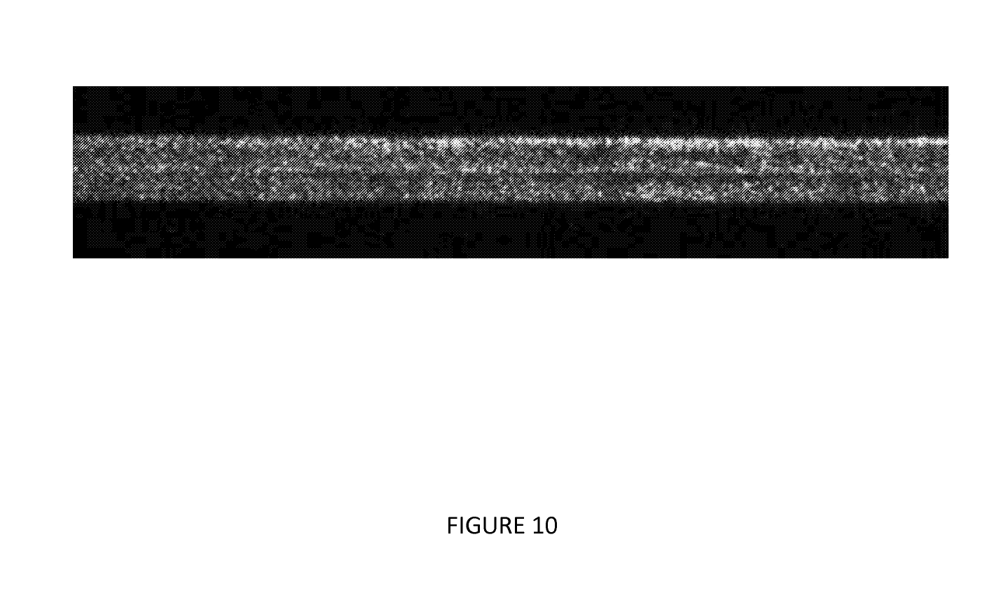

As demonstrated in FIG. 8, a bare TFBG out-couples the core guided light into the liquid where it excites yellow luminescence from Rhodamine in solution. Here, because the liquid contains molecules that luminesce, light extracted from the fiber is visible all along its path through the liquid. In air, argon laser light is still extracted out of the fiber (at a different angle), but is only visible when it strikes a screen or other scattering medium outside the fiber (FIG. 9). For the comparison, a TFBG with particulate coating was manufactured as described in Example 2. In contrast to the bare fiber, the light from the Argon laser was able to escape through gaps in the coating and scattered strongly in and around the coating (FIG. 10), instead of radiating straight out as observed in FIGS. 8 and 9.

1. An apparatus comprising an optical fiber with a grating and a particulate coating located over at least a portion of the grating.

2. The apparatus of claim 1, wherein the grating is imprinted in a core of the optical fiber.

3. The apparatus of claim 1, wherein the length of the grating is between 1 and 100 mm.

4. The apparatus of claim 1, wherein the particulate coating comprises spheroid particles.

5. The apparatus of claim 4, wherein the spheroid particles are selected from the group consisting of cubes, near cubic rectangles, spheres, near spherical ellipsoids, other irregular shapes with substantially similar dimensions in all directions, and combinations thereof.

6. The apparatus of claim 5, wherein the spheroid particles have dimensions between 1 and 5000 nm.

7. The apparatus of claim 5, wherein the spheroid particles have dimensions between 10 and 500 nm.

8. The apparatus of claim 5, wherein the spheroid particles have dimensions between 30 and 100 nm.

9. The apparatus of claim 1, wherein the particulate coating comprises particles with asymmetric shapes with substantially different dimensions in at least two directions.

10. The apparatus of claim 9, wherein the particulate coating comprises metal nanowires or carbon nanotubes.

11. The apparatus of claim 9 wherein the particles have a diameter between 1 and 1000 nm and a length between 500 and 20000 nm.

12. The apparatus of claim 11, wherein the particles have a diameter between 10 and 100 nm and a length between 1000 and 5000 nm.

13. The apparatus of claim 1, wherein the particulate coating covers between 10 and 90% of the surface of the optical fiber located over the grating.

14. The apparatus of claim 1, wherein the particulate coating exists in a plurality of discontinuous sections each ranging from 1-100 mm in length where the particulate coating covers between 10 and 90% of the surface each section.

15. The apparatus of claim 14, wherein the plurality of discontinuous sections comprise the same particulate coating.

16. The apparatus of claim 14, wherein the plurality of discontinuous sections comprises at least two sections with different coatings.

17. The apparatus of claim 1, wherein the particulate coating has a thickness in the range of 1 to 5000 nm.

18. The apparatus of claim 1, wherein the particulate coating has a thickness in the range of 10 to 500 nm.

19. The apparatus of claim 1, wherein the particulate coating has a thickness in the range of 30 and 100 nm.

20. The apparatus of claim 1, wherein the particulate coating comprises metal particles.

21. The apparatus of claim 20, wherein the metal particles are particles of silver, gold, copper, aluminum, nickel, titanium, cadmium, iron, tin, lead, zinc, or a combination thereof.

22. The apparatus of claim 20, wherein the metal particles are particles of silver.

23. The apparatus of claim 22, wherein the metal particles are silver nanoparticles.

24. The apparatus of claim 22, wherein the metal particles are spheroid silver nanoparticles or silver nanowires.

25. The apparatus of claim 1, wherein the particulate coating is at least partially transparent to radiation of a first wavelength and substantially opaque to radiation of a second wavelength.

26. The apparatus of claim 25, wherein the first wavelength is in the visible region and the second wavelength is in the infrared region.

27. The apparatus of claim 26, wherein the second wavelength is in the near infrared region.

28. A system comprising the apparatus of claim 1, a source of radiation, a means for coupling radiation from the source into the optical fiber, a sample comprising an analyte where the optical fiber is at least partially immersed within the sample, and a means for detecting the analyte in the sample once excited by radiation emanating from the optical fiber.

29. The system of claim 28 further comprising a means for cooling the sample.

30. The system of claim 28 further comprising a chamber that contains the sample.

31. The system of claim 30 further comprising a means for managing the transport of the sample and optical fiber into the chamber.

32. The system of claim 28, wherein the system is capable of simultaneous heating of the sample and optical detection of the analyte in the sample.

33. The system of claim 32, wherein heating is caused by radiation of a first wavelength that is absorbed by the particulate coating and optical detection relies on radiation of a second wavelength that passes through the particulate coating.

34. The system of claim 33, wherein the first wavelength is in the infrared region.

35. The system of claim 33, wherein the first wavelength is in the near infrared region.

36. The system of claim 33, wherein the second wavelength is in the visible region.

37. The system of claim 30, wherein the chamber is cylindrical in shape.

38. The system of claim 30, wherein the chamber is cylindrical in shape with a tapered bottom end.

39. The system of claim 30, wherein the chamber is conical in shape.

40. The system of claim 30, wherein the chamber is composed of a material comprising an inert polymer.

41. The system of claim 40, wherein the inert polymer is polyvinylchloride, polyethylene, polypropylene, or a combination thereof.

42. The system of claim 40, wherein the chamber is composed of a material comprising a heat retentive material.

43. The system of claim 30, wherein the chamber is composed of a material that is transparent to visible light.

44. The system of claim 30, wherein the chamber is composed of a material that is both transparent to visible light and does not luminesce under visible light.

45. A method comprising using an apparatus of claim 1, or a system of claim 28, to simultaneously heat a sample comprising an analyte and detect the analyte in the sample.

46. The method of claim 45, wherein the heating is used to perform DNA amplification.

47. The method of claim 45, wherein the detecting is based on fluorescence excitation.

48. The method of claim 47, wherein the fluorescence excitation is amplified by plasmon resonance effects.

49. The method of claim 45, wherein the detecting is based on Raman scattering excitation.

50. The method of claim 49, wherein the Raman scattering excitation is amplified by Surface Enhanced Raman Scattering (SERS).

51. The method of claim 45, wherein the apparatus is further used to measure the temperature of the sample.
